(19) United States
(12) Patent Application Publication
(10) Pub. No.: US 2009/0130013 A1
(43) Pub. Date: May 21, 2009

(54) METHODS AND SYSTEMS FOR ENHANCING MERCURY, SELENIUM AND HEAVY METAL REMOVAL FROM FLUE GAS

(75) Inventor: Thomas E. Higgins, Reston, VA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: CH2M HILL, Inc., Englewood, CO (US)

(21) Appl. No.: 12/167,139

(22) Filed: Jul. 2, 2008

Related U.S. Application Data
(60) Provisional application No. 60/989,766, filed on Nov. 21, 2007.

(51) Int. Cl. C01B 17/00

(52) U.S. Cl. 423/242.1

(57) ABSTRACT

A method for treating flue gas may include adding iron to a slurry in a ratio between approximately 20-to-1 and 5000-to-1 by weight of iron to a weight of mercury, selenium or other heavy metal to be removed from the flue gas, and contacting the slurry with the flue gas in a flue gas desulfurization system. A system for treating flue gas may include a scrubber, a slurry tank, and a water source. Water and limestone may be combined in the slurry tank to form a limestone slurry. At least a portion of the limestone slurry may be used to treat flue gas in the scrubber. Iron may be added to at least a portion of the limestone slurry used to treat flue gas in the scrubber. The iron used in either the method or system may be a ferrous or ferric salt, or elemental iron.

### CROSS-REFERENCE TO RELATED APPLICATIONS

This application claims under 35 U.S.C. § 119(e) the benefit of U.S. Provisional Application No. 60/989,766, entitled “Methods and System for Removing Heavy Metals from Flue Gas” and filed Nov. 21, 2007, which is hereby incorporated by reference herein in its entirety.

### FIELD OF INVENTION

The present invention generally relates to methods and systems for enhancing mercury, selenium and heavy metal removal from coal-fired power plant flue gas.

### BACKGROUND

U.S. coal-fired power plants emit an estimated 48 tons of mercury per year into the atmosphere. On Mar. 15, 2005, the United States Environmental Protection Agency issued the Clean Air Mercury Rule (CAMR) that caps mercury emissions from coal fired power plants to 15 tons/year by 2018.

Tightening air regulations are also forcing removal of acid-forming gasses, principally oxides of sulfur and nitrogen. To remove such gasses, some electric utilities are installing flue gas desulfurization (FGD) systems, typically in the form of wet scrubbers. Most newly installed FGD systems utilize the limestone slurry forced oxidation (LSFO) process, in which SO₂ is absorbed in pulverized limestone slurry droplets falling through the flue gas under chemically reducing conditions and reacting with the limestone to produce carbon dioxide and calcium sulfite. The slurry droplets fall to a pool of slurry at the bottom of the FGD system (the oxidation reactor), where air is added to create a chemical oxidizing environment to oxidize sulfite to sulfate. The sulfate is precipitated with calcium to produce calcium sulfate (gypsum). This precipitation is carried out so as to produce large gypsum particles through crystallization. Additional limestone slurry is added to the reactor, and the mixture, which may contain the additional limestone as well as unreacted limestone, is pumped from the oxidation reactor and sprayed into the absorber to remove additional gasses.

In addition to acid gas removal, metals, including mercury and selenium, are absorbed in the limestone slurry in FGD scrubbers. It was thought that FGD scrubbers would be highly efficient at removing mercury from the flue gas. However, existing FGD scrubbers are less effective at removing mercury than anticipated.

There are at least three forms of mercury in the flue gas: particulate, oxidized, and elemental. The first two are generally removed with a high efficiency by a FGD system. Although elemental mercury is also absorbed, it may be readily desorbed from the FGD solution and lost up the stack in a process referred to as re-emission. If oxidized mercury is reduced to its elemental form after capture in an FGD system, it may also be re-emitted. There appears to be a tendency for FGD systems to reach a limit on the mass of mercury that can be held in the FGD slurry, with mercury above the limit being lost up the stack.

Selenium can be present in coal fired flue gas and FGD slurries in at least two oxidized forms: selenite and the more oxidized selenate. Both forms of selenium are soluble in water. However, selenite may be removed from wastewater (including wastewater produced by FGD systems) by sorption or co-precipitation with iron hydroxide at a pH in the 5.5 to 6.5 range. Selenate, the more oxidized of the two forms, cannot be removed by this process. Earlier FGD scrubbers employed only an absorption process and produced a calcium sulfite product. These “inhibited oxidation” or “natural oxidation” FGD systems tended to produce wastewater containing mostly selenite. Forced oxidation FGD systems tend to produce more selenate, likely generated when the FGD slurry is in the oxidation reactor. Therefore, the wastewater generated by these FGD systems tends to have more selenate in the FGD slurry, resulting in a wastewater that is more difficult to treat.

### BRIEF SUMMARY

One embodiment of the present invention may take the form of a method for treating flue gas. The method may include adding iron to a limestone slurry at a ratio of between approximately 100-to-1 and 5000-to-1 by weight of iron to a weight of mercury to be removed from a flue gas. The method may further include contacting the limestone slurry containing the added iron with the flue gas in a flue gas desulfurization system.

Another embodiment of the present invention may take the form of a method for treating flue gas. The method may include adding iron to a limestone slurry at a ratio of between approximately 20-to-1 and 1000-to-1 by weight of iron to a weight of selenium to be removed from a flue gas. The method may further include contacting the limestone slurry containing the added iron with the flue gas in a flue gas desulfurization system.

Yet another embodiment of the present invention may take the form of a method for treating flue gas. The method may include adding iron to a limestone slurry at a ratio of between approximately 20-to-1 and 5000-to-1 by weight of iron to a weight of at least one heavy metal to be removed from the flue gas. The method may further include contacting the limestone slurry containing the added iron with the flue gas in a flue gas desulfurization system.

### BRIEF DESCRIPTION OF THE DRAWINGS

FIG. 1 depicts a schematic view of a ferric hydroxide solid.

FIG. 2 depicts a schematic view of the ferric hydroxide solid of FIG. 1 with mercury and selenite precipitated onto it.

FIG. 3 depicts a schematic view of the ferric hydroxide, mercury and selenite precipitate of FIG. 2 covered by an iron hydroxide layer.

FIG. 4 depicts a schematic view of a first example of a system for treating flue gas.

FIG. 5 depicts a schematic view of a second example of a system for treating flue gas.

FIG. 6 depicts a schematic view of a FGD chemistry simulator.

FIG. 7 depicts a graph of the concentration of soluble mercury in the slurry versus time for Run 3 of a FGD chemistry simulation.

FIG. 8 depicts a graph of the concentration of soluble mercury in the slurry versus time for Run 9 of a FGD chemistry simulation.

FIG. 9 depicts a graph of measured particulate iron and mercury concentrations in various FGD slurries.

FIG. 10 depicts a graph of measured particulate selenium and mercury concentrations in various FGD slurries.

FIG. 11 depicts a graph of measured particulate arsenic and mercury concentrations in various FGD slurries.

FIG. 12 depicts a graph of measured particulate copper and mercury concentrations in various FGD slurries.

### DETAILED DESCRIPTION

Described herein are methods and systems for adding various forms of iron to flue gas desulfurization (“FGD”) systems to enhance removal from the flue gas of mercury, selenium and/or one or more heavy metals, such as cadmium, arsenic, lead and nickel. Adding iron to a FGD system reduces re-emission of mercury, and thus increases the effective removal efficiency of mercury from the flue gas, as well as potentially producing a co-precipitate with iron hydroxide. For selenium, the reaction of selenite with iron in a FGD system may reduce the formation of selenate, and may result in the absorption or precipitation of reduced forms of selenium with iron hydroxide. Due to the recycle of solids between the sorption tower and oxidation reactor of a conventional forced oxidation FGD system, the iron hydroxide precipitation reaction can be manipulated to produce larger solid particles consisting of ferric hydroxide, mercury and selenium, thus enhancing the removal of these particles in a subsequent wastewater treatment solids removal process.

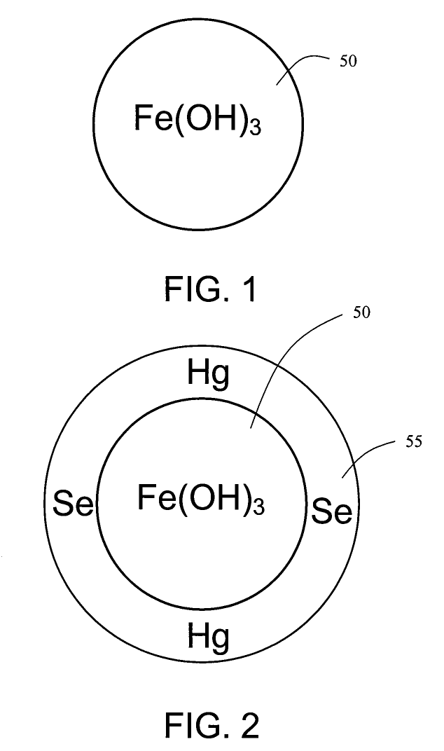

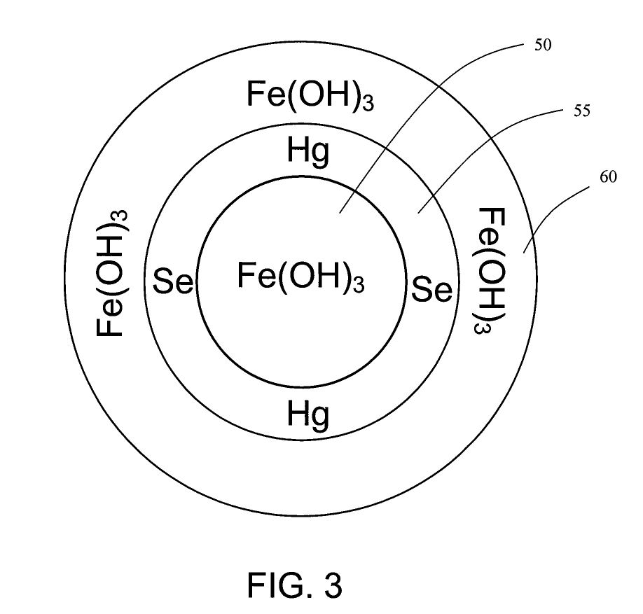

More particularly, it is believed that when iron is added to the FGD system, it is precipitated with hydroxide to form a ferric hydroxide solid 50 as shown schematically, for example, in FIG. 1. Mercury may then form a precipitate using the ferric hydroxide solid 50 as a surface to precipitate on in a process called iron co-precipitation as shown schematically, for example, in FIG. 2. Selenite may also co-precipitate with the ferric hydroxide or be absorbed on the ferric hydroxide surface as shown schematically, for example, in FIG. 2. Other metals, such as copper, arsenic, lead, cadmium may behave similarly, thus forming a mixed metal precipitate on the surface of the iron hydroxide particles. When additional iron is added to the FGD system, it may precipitate as iron hydroxide on top of the other metals as shown schematically, for example, in FIG. 3.

Since the mercury is covered (or substantially covered) by an iron hydroxide layer 60 as shown, for example, in FIG. 3, it cannot dissolve or be available for chemical reduction to its elemental form and be re-released into the flue gas. Additional mercury (and other metals, such as, copper, arsenic, lead, cadmium and so on) may continue to precipitate on the new iron surface 60, resulting in much lower concentrations of these metals than would occur if the iron were not present and actively precipitating and forming subsequent layers covering the additional metals. Likewise, selenite is covered, protecting it from oxidation to selenate, thus reducing the concentration of selenate formed in the FGD system.

The method may include adding iron to a limestone or other slurry before the slurry is sprayed or otherwise distributed in a scrubber absorber. The iron may be a ferrous or ferric salt, an iron oxide/hydroxide sorbet media, elemental iron, or other iron reagent. If added as a ferric salt, iron may form ferric hydroxide and sorb the selenite. FGD scrubbers typically operate at about a pH of between approximately 5.5 and 6, which is a favorable pH range for this reaction with selenite. If ferrous salt is used, the iron may be oxidized to ferric iron, perhaps reacting with and chemically reducing any selenate that may have been formed or oxidized by air in the oxidation reactor, with the ferric iron precipitating as hydroxide and sorbing selenite. If elemental iron is used, the reaction could be combination of selenite and selenate reduction, ferric hydroxide formation and sorption of selenite on the resulting iron oxide/hydroxide particle surface.

Adding iron to the slurry utilizes the reducing conditions in the FGD scrubber to react the added iron with selenite in the scrubber before the selenite enters the oxidizing reactor, thus converting selenium in the treated flue gas to a solid before it can be oxidized to selenate. The resulting selenium containing solids may then be removed from the reactor wastewater using a conventional liquid-solids removal process.

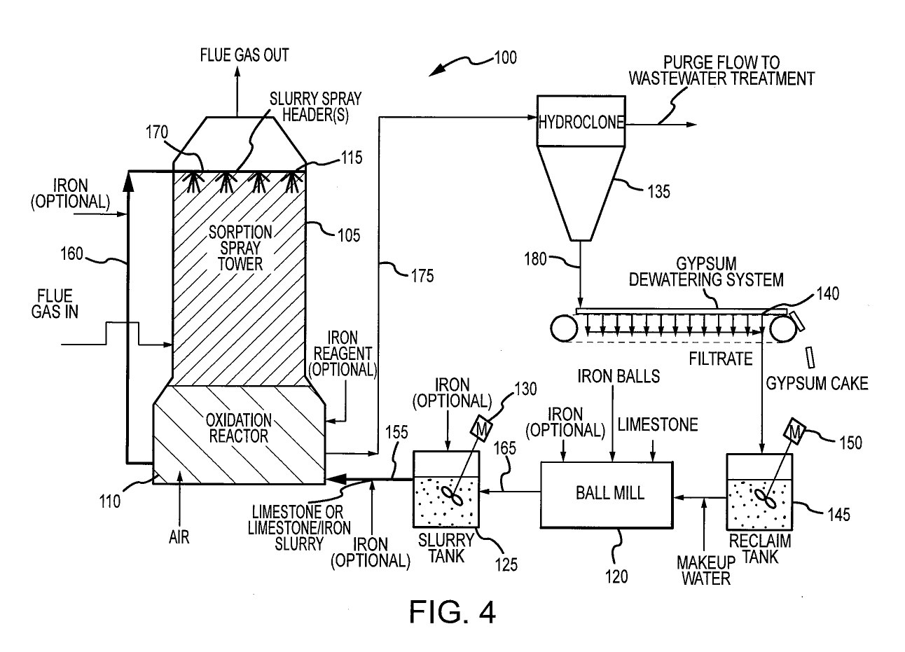

FIG. 4 depicts a schematic view of a first example of a FGD system 100 to enhance mercury, selenium and/or heavy metal removal. In this FGD system 100, sorption occurs in a scrubber 105, such as a spray tower, where flue gas passes through a spray of a limestone, lime or other slurry before the slurry passes to an oxidation reactor 110. The slurry may or may not be a re-circulating slurry. The oxidation reactor 110 may be located at a lower end portion of the scrubber 105, or in a tank separate from the scrubber 105, and the absorber may extend from the oxidation reactor 110 to an upper portion of the tower 105. In some versions of the FGD system 100, the oxidation reactor 110 may be replaced with a slurry tank. The scrubber 105 may further include one or more sprayers 115 positioned at an upper end portion of the scrubber 105. The sprayers 115 may be in fluid communication with the oxidation reactor via one or more pipes or other suitable fluid conveyance devices or systems.

The FGD system 100 may further include air injection to provide oxygen to the oxidation reactor 110. In some versions of the FGD system 100, air may not be injected. In such versions of the FGD system 100, the scrubber 105 may be operated as a natural oxidation or as an inhibited oxidation scrubber. In the oxidation reactor 110, sulfite is oxidized to sulfate, which can combine with calcium from the limestone to precipitate as gypsum. Limestone may be mixed with water and pulverized to a powder in a ball mill 120 or other known device for converting limestone into limestone powder and slurrying it with water. The ball mill 120 may include iron or other sufficiently hard balls for grinding the limestone into limestone powder. The slurry tank 125 may include a mixer 130 to facilitate creation of the limestone slurry for use in the FGD system 100.

The FGD system 100 may further include a solids dewatering system 135. Some versions of the solids dewatering system 135 may include a hydroclone to separate wastewater received from the oxidation reactor 110 into two liquids streams: one containing large particles of gypsum, which flows to a gypsum dewatering system 140, and another containing smaller particles, which is directed to a wastewater treatment plant and/or recycled back into the FGD system 100. The filtrate from the gypsum dewatering system 140 may be transferred to a reclaim tank or pond 145. The reclaim tank or pond 145 may include a reclaim mixer 150 and may be used to supply water for grinding and/or slurrying the limestone. Fresh water may also be added as makeup water to replace water lost in the process.

Iron may be added to the flue gas treatment system 100 at one or more locations within the system 100. With reference to FIG. 1, iron may be added to the ball mill 120, the slurry tank 125, the oxidation reactor 110, into a conduit 155 fluidly joining the slurry tank 125 to the oxidation reactor 110, or into a conduit 160 fluidly joining the oxidation reactor 110 to the sprayer 115. The location or locations where iron is added may depend upon the state of the iron (ferrous, ferric or elemental; and solid particle, solid powder, or liquid) and/or whether the iron reactions are needed in the oxidation reactor 110 and/or the sorption tower. As an example, if the design requires the iron to be initially added to the oxidation reactor 110 and the iron is in a solid particle state (e.g., ferrous carbonate—FeCO₃, pyrite—FeS₂, or elemental iron), the iron may be added to the ball mill 120 to be ground into powder and slurried with the limestone. Continuing with the example, the iron powder may be added to the slurry tank 125 for mixing it with the limestone slurry and then delivered to the FGD system 100.

As another example, if the design requires the iron to be initially added to the sorption tower and the iron is in a liquid form (e.g., ferrous chloride—FeCl₂ or ferric chloride—FeCl₃), the iron may added to the conduit 160 that delivers limestone slurry from the oxidation reactor 110 to the spray nozzles in the sorption tower. If, in the previous example, the iron was in a solid particle state, it could first be ground into powder using any known method and mixed with water before being added to the conduit 160 that delivers limestone slurry from the oxidation reactor 110 to the sprayers 115. The foregoing examples are merely illustrative and are not intended to be limiting.

The amount of iron added to the flue gas treatment system 100 may be a function of the desired amount of mercury, selenium or other heavy metal to remove from the flue gas. More particularly, the amount of iron added may be between ratios by weight of approximately 100-to-1 and 5000-to-1 of iron to mercury, between approximately 20-to-1 and 1000-to-1 for the ratio of iron to selenium, and between approximately 20-to-1 and 5000-to-1 for the ratios of iron other heavy metals, such as cadmium, arsenic, lead and nickel. For systems 100 where more than one heavy metal will be removed, the heavy metal with the greatest or maximum amount of weight to be removed may be used to determine the amount of iron required at a given ratio. For example, if the desired iron to heavy metal ratio was 100-to-1 and the desired weights of arsenic and lead to be removed were 1 lb. and 2 lbs., respectively, then 200 lbs of iron may be added to achieve the ratio of 100-to-1. The foregoing example is merely illustrative and is not intended to imply or require a particular ratio of iron to heavy metal, any particular number regarding the amount of any heavy metal to be removed or iron to be added, or any particular combination (if any) of heavy metals to be removed.

The ratio for iron to either mercury, selenium or other heavy metals may depend, in part, on the amount of iron already present in the system 100. More particularly, limestone may contribute varying amounts of iron. Further, when limestone is ground into powder by iron balls, corroded and/or eroded iron from the balls may mix with the limestone slurry. Accordingly, some flue gas treatment systems 100 may have a greater base level of iron than other flue gas treatment systems 100, and thus may require lesser amounts of additional iron to remove a given amount of mercury, selenium, or other heavy metal from the flue gas. Testing for the concentration of iron within the limestone may be done to estimate the minimum additional iron required for a particular system and/or for a select time frame for the system. The select time frame could be hourly, daily, monthly, quarterly, or any other time period.

The iron added to the flue gas treatment system 100 may take one or more forms. The iron may be ferrous, ferric or elemental iron. Ferrous irons may include ferrous carbonate (FeCO₃), ferrous chloride (FeCl₂), ferrous sulfate (FeSO₄), pyrite (FeS₂), and so on. Ferric irons may include ferric chloride (FeCl₃), ferric sulfate (Fe₂(SO4)₃), and so on. When using ferrous carbonate, a new anion species will not be added to the flue gas treatment system 100 since limestone includes carbonate. Pyrite is often a waste product generated by a coal-fired power plant, and thus may provide a relatively inexpensive source of iron when treating the flue gas produced by a coal-fired power plant.

Operation of the flue gas treatment system 100 shown in FIG. 4 will now be described. Limestone and water may be supplied to the wet ball mill 120 and ground into a powder slurry. The limestone slurry is then transferred to the slurry tank 125 by a conduit 165 or any other known slurry transportation method or device. In the slurry tank 125, the slurry may be mixed with additional water. The water used for the ball mill 120 and the slurry tank 125 may be supplied from a water source and/or from water reclaimed from the solids dewatering system 135 or from a wastewater treatment system.

The limestone slurry is transported from the slurry tank 125 to the scrubber 105 via conduits 155, pipes, or any other known slurry transportation system. Pumps or other devices or systems may be used as required to move the limestone slurry from the slurry tank 125 to the oxidation reactor 110. To create an oxidizing environment, air may be supplied to the oxidation reactor 110 from an air source using pipes, conduits, or any other known method for transporting a gas. Blowers, fans, or other devices or systems may be used as required to move the air from the air source to the oxidation reactor 110.

At least a portion of the limestone slurry contained within the oxidation reactor 110 may be transported to slurry spray header(s) 170 in fluid communication with the sprayers 115 via pipes, conduits 160, or any other known device or system for transporting a slurry. Again, pumps or other devices may be used as needed. The limestone slurry exits the spray heads of the sprayers 115 and falls, under the influence of gravity, towards the oxidation reactor 110. As the limestone slurry falls, it contacts the flue gas flowing in the scrubber 105.

More particularly, the flue gas enters the scrubber 105 at a lower end portion of the scrubber 105 and exits at an upper end portion. Thus, as the flue gas flows upward in the scrubber 105 from the lower end portion to the upper end portion of the scrubber 105, it contacts the downwardly traveling limestone slurry spray. As the flue gas contacts the limestone slurry spray, the various chemical compounds contained within the flue gas may be absorbed by the slurry and react with or be sorbed by the various chemical compounds in the limestone slurry, thus removing at least some of the chemical compounds from the flue gas. As discussed in more detail above, iron may be added to the limestone slurry at one or locations in the flue gas treatment system 100 to enhance removal of mercury, selenium, or other heavy metals from the flue gas and generate a solid precipitate that can be removed from the resulting wastewater.

At least a portion of the liquid contained within the oxidation reactor 110 may be removed from the oxidation reactor 110 and transported to the solids dewatering system 135. More particularly, the removed liquid may be transported from the oxidation reactor 110 to the solids dewatering system 135 via pipes, conduits 175, or any other known method for transporting liquids. As discussed with respect to other piping, pumps or other devices may be used as needed. The solids dewatering system 135 separates the fine particles from the coarse particles in the liquid. The portion of the liquid containing the fine particles may overflow from the solids dewatering system 135. At least a portion of the overflow liquid may be transferred to a wastewater treatment system. This overflow liquid may also contain chlorides. Although not shown, at least a portion of the overflow liquid may be delivered to the reclaim tank 145 for reuse in the flue gas treatment system 100, if desired.

The underflow from the solids dewatering system 135, which may contain the coarse particles, is delivered to the gypsum dewatering system 140 via pipes, conduits 180, or any other known method for transporting liquids. The gypsum dewatering system 140 separates gypsum solids from the liquid, producing a gypsum cake and a low suspended solids filtrate. At least a portion of the filtrate may be transferred to the reclaim tank 145 for further use in the flue gas treatment system 100. Any liquid not transferred to the reclaim tank 145 may be delivered to a wastewater treatment system.

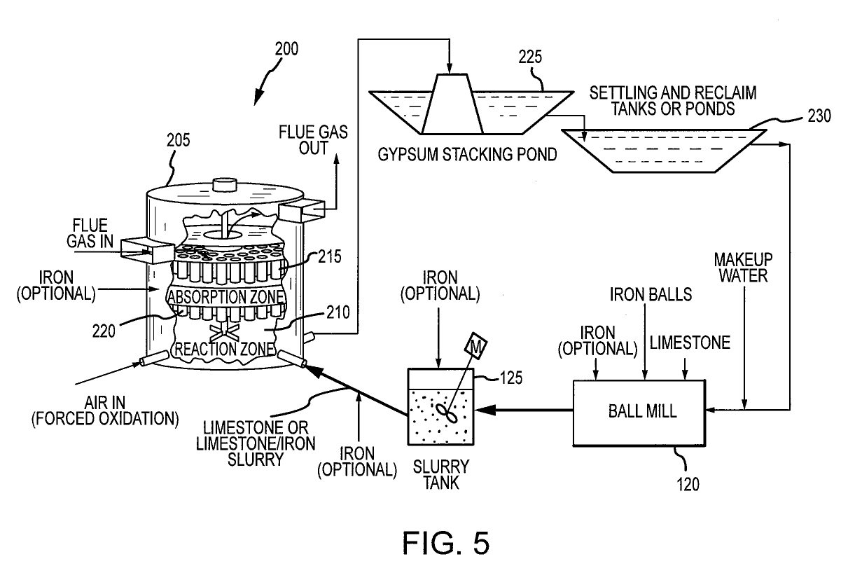

FIG. 5 depicts a second example of a FGD system 200. The second FGD system 200 is similar to the first FGD system 100 and may operate in a similar manner. Like the first FGD system 100, the second FGD system 200 may include a ball mill 120 and a slurry tank 125. However, in the second FGD system 200, the spray tower absorber of the first system 100 is replaced with a jet bubbler absorber 205. Like the FGD system 100 shown in FIG. 4, a lower portion of the jet bubbler absorber 205 contains an oxidation reaction zone 210 and an upper portion contains an absorption zone 215. Unlike a spray tower scrubber 105 as shown in FIG. 4, limestone slurry is not delivered from the oxidation reaction zone 210 to the jet bubbler absorption zone 215 via a sprayer. Instead, the limestone slurry substantially fills the jet bubbler absorber 205 and slurry moves between the two zones by mixing effects. Air is supplied from an air source to the oxidation reaction zone 210 to produce oxidizing conditions in the lower portion of the jet bubbler absorber 205. Slurry in the absorption zone 215 is kept low in oxygen by the reaction with the flue gas passing through jet bubblers 220.

In the second FGD system 200, the solids dewatering system may be similar to that in the first system, or may be modified. More particularly, the hydroclone and gypsum dewatering system may be replaced with a gypsum stacking system 225 and a settling tank or pond 230. Like the solids dewatering system for the first example, however, gypsum and other particulates produced in the second FGD system 200 are separated from the liquid, and a portion of the separated liquid may be delivered to a reclaim tank for reuse in the FGD system.

The solids dewatering system shown in FIG. 5 could be used with the scrubber shown in FIG. 4, and the solids dewatering system shown in FIG. 4 could be used with the jet bubbler shown in FIG. 5. Further, the solids dewatering systems shown in FIGS. 4 and 5 could be omitted or replaced with any other known dewatering or wastewater treatment system. Thus, it should be understood that the dewatering and wastewater treatment systems shown and described herein are merely illustrative and are not intended to imply or require any particular dewatering or wastewater treatment system for use in the flue gas treatment system. Moreover, any FGD system that has at least one absorption zone and at least one oxidation zone, including the forced oxidation tower scrubber and the jet bubbler scrubber described herein, may be used in the FGD system. Moreover, the iron addition process may be applied to any FGD system that has only an absorption zone or to any FGD system that does not employ an oxidation reactor.

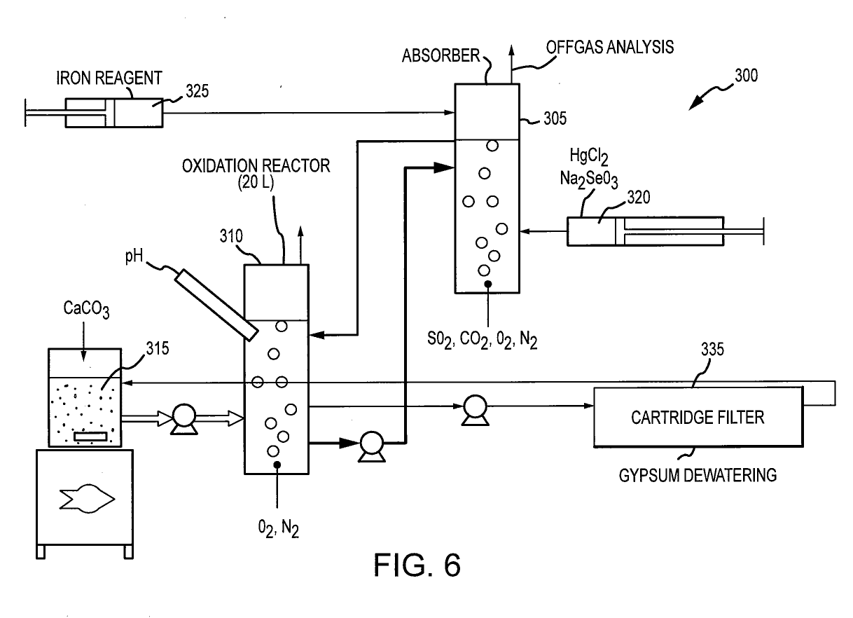

A FGD chemistry simulator 300 was constructed to model mercury emissions and selenate formation in a FGD system with and without iron addition. FIG. 6 depicts a schematic diagram of the FGD chemistry simulator 300. The simulator 300 includes separate absorption and oxidation reactors 305, 310. Limestone slurry 315 is added to the oxidation reactor 310. Slurry is pumped from the oxidation reactor 310 to the absorption reactor 305. In the absorption reactor 305, a mixture of gasses containing sulfur dioxide, nitrogen, oxygen and carbon dioxide are sparged into the slurry to simulate the flue gas.

Dissolved mercuric chloride and sodium selenite are metered into the slurry using a metering pump 320 to simulate absorption of these metals. The slurry is then pumped into the oxidation reactor 310. Air containing excess oxygen is sparged into the oxidation reactor 310 to provide oxidizing conditions. Iron salts are added to either the absorption or oxidation reactor 305, 310 using a second metering pump 325. The concentrations of soluble mercury and selenium are monitored over time to determine if the metals are being precipitated. Selenate concentration is monitored to determine if the formation of selenate is inhibited by the iron addition. Off-gasses from the two reactors are analyzed for mercury. Mercury emissions are compared between a run where iron is added to the simulator 300 and a comparable run with no iron addition to determine the effectiveness of iron addition.

To simulate the chemistry of a FGD system, the simulator 300 was loaded with a slurry from an operational FGD system, then various simulations were conducted. Table 1 below summarizes the input data and mercury emission results for 10 runs of the FGD chemistry simulator, where various iron salts (except for Runs 1, 2 and 10B) were added in conjunction with mercuric chloride and sodium selenite.

Column 1 in Table 1 indicates the simulation run number. Column 2 shows the rate that mercury was fed into the simulator 300 for each run. Column 3 identifies the type of iron used in each run. Column 4 shows the rate that iron, if any, was fed into the simulator 300 for each run, and column 5 shows the rate that sulfide, if any, was fed into the simulator 300 for each run. Column 6 contains information about the measured mercury concentrations, and column 7 shows the percentage reduction in mercury emissions for a non-baseline run when compared to an appropriate baseline run.

TABLE 1
Data from FGD Simulator Runs

| | Hg Feed | | Fe Feed | S⁼ Feed | | |
|---|---|---|---|---|---|---|
| | Rate | | Rate | Rate | Hg Emission | Hg Emission |
| Run | (ug/Min) | Fe Type | (mg/Min) | (mg/Min) | (ug/Min) | Reduction (%) |
| (1) | (2) | (3) | (4) | (5) | (6) | (7) |
| 1 | 0.63 | None | 0 | 0 | 0.090 | Baseline for runs 3-9 |
| 2 | 0.63 | None | 0 | 0 | 0.087 | |
| 3 | 0.63 | FeCl₃ | 0.84 | 0 | 0.014 | 84% |
| 4 | N/A | N/A | N/A | N/A | N/A | Run Aborted |
| 5 | 0.63 | FeCl₂ | 0.76 | 0.05 | 0.034 | 62% |
| 6 | 0.63 | Siderite | 2.1 | 0 | 0.031 | 66% |
| 7 | 0.63 | Siderite | 4.1 | 1.1 | 0.029 | 68% |
| 8 | 0.84 | FeCl₃ | 6.7 | 0.89 | 0.043 | 52% |
| 9 | 0.84 | FeCl₃ | 15.4 | 3.8 | 0.022 | 76% |
| 10A | 8.5 | FeCl₃ | 21.4 | 0 | 0.016 | 77% |
| 10B | 8.5 | None | 0 | 0 | 0.069 | Baseline for 10A |

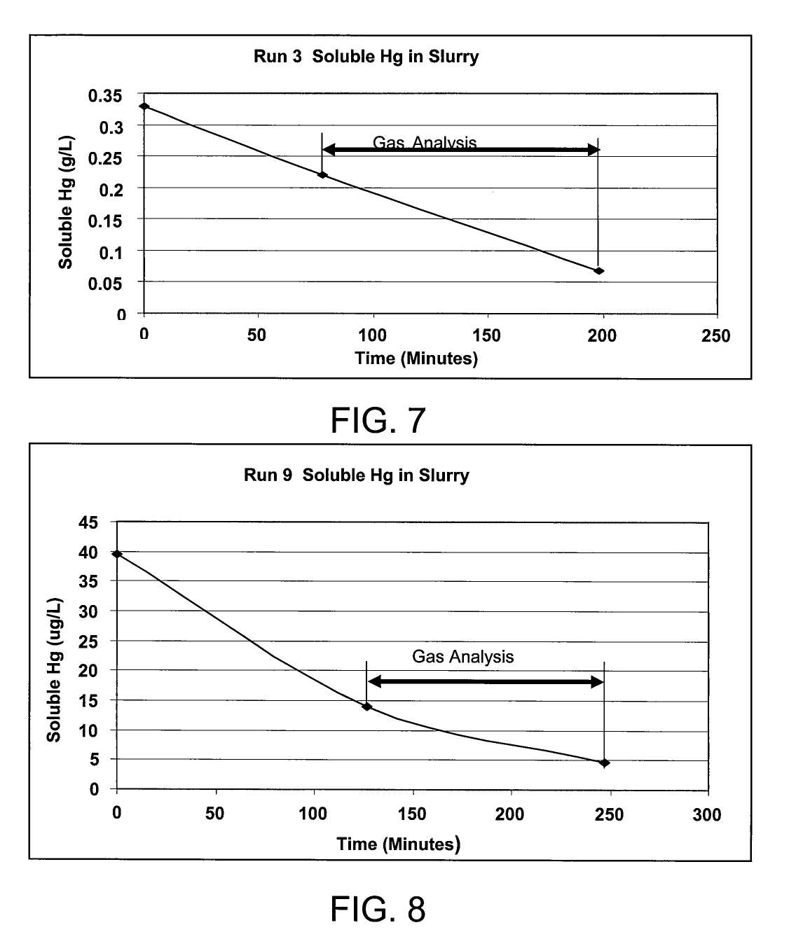

Runs 1, 2 and 10B were performed without any iron addition to establish a baseline for comparison to runs that included iron addition. In Run 3, ferric chloride was added for 2 hours followed by a 2 hour air sample. The air emissions of mercury in Run 3 were reduced by 84 percent compared to air emissions of mercury in baseline Runs 1 and 2. FIG. 7 depicts a graph of the concentration of soluble mercury in the slurry versus time during Run 3.

With reference to FIG. 7, soluble mercury concentration declined throughout Run 3. Since mercury re-emission is believed to be associated with soluble mercury, it appears that if Run 3 was longer, additional reduction in mercury re-emission would have been achieved. Also, since the soluble mercury concentration was declining, it is likely that a lower dose of iron would be required to maintain low mercury solubility after equilibrium was achieved. Since the average hydraulic detention time (HDT) in an FGD system is on the order of days, this iron addition equilibrium takes place in a fraction of the HDT of an operating FGD system. Accordingly, it is believe that iron addition to a FGD system may achieve higher than the 84 percent reduction in mercury re-emission as observed in Run 3.

Run 4 was aborted for technical reasons. Additional runs were completed with ferric chloride plus sodium sulfide (Run 5); ferrous carbonate (siderite) (Run 6); siderite plus sulfide (Run 7); ferric chloride plus sulfide (Runs 8 and 9). Mercury emission reduction was observed for each of Runs 5-9. However, the mercury emission reductions were generally less than the mercury reductions observed for the Run 3 (ferric chloride with no sulfide addition), thus resulting in higher concentrations of soluble mercury. For example, FIG. 8 shows the soluble mercury concentration versus time for Run 9 (ferric chloride plus sulfide). With reference to FIG. 8, soluble mercury was reduced over time by the addition of the ferric sulfide. However, in comparison to the soluble mercury concentrations for Run 3 (ferric chloride only), the soluble mercury concentration was greater. This greater measured soluble mercury concentration may possibly be due to the formation of colloidal iron and mercury sulfide particles, which reduced re-emission, but passed through the 0.45 micron filters used to differentiate soluble from particulate. Run 10A (only ferric chloride) demonstrated the effectiveness of iron addition with high mercury loading.

Runs 10A and B were performed to determine the impacts of iron addition on selenate formation. Since the FGD slurry contained a significant concentration of soluble selenate, and the proposed mechanism of iron addition is to tie up selenite before it can be oxidized to selenate, it was unfeasible to demonstrate reduction in selenate formation when starting with the existing FGD system slurry. Accordingly, Runs 10A and B were performed using a modified procedure.

The FGD simulation slurry was filtered through a cartridge filter 330 to trap solid gypsum and other particles. The trapped gypsum solids were re-suspended and washed with a calcium chloride solution (matching the salinity of the original slurry), and reconstituted with additional calcium chloride solution. During this run, sodium selenite was fed at a rate of 1,500 ug/L-hr (as Se). Without iron addition (Run 10B) selenate was formed at a rate of 113 ug/L-hr. When iron was added (Run 10A), selenate formation was formed at a rate of 70 ug/L-hr, demonstrating that at an iron to selenium ratio of 100-to-1, there was a reduction in selenate formation.

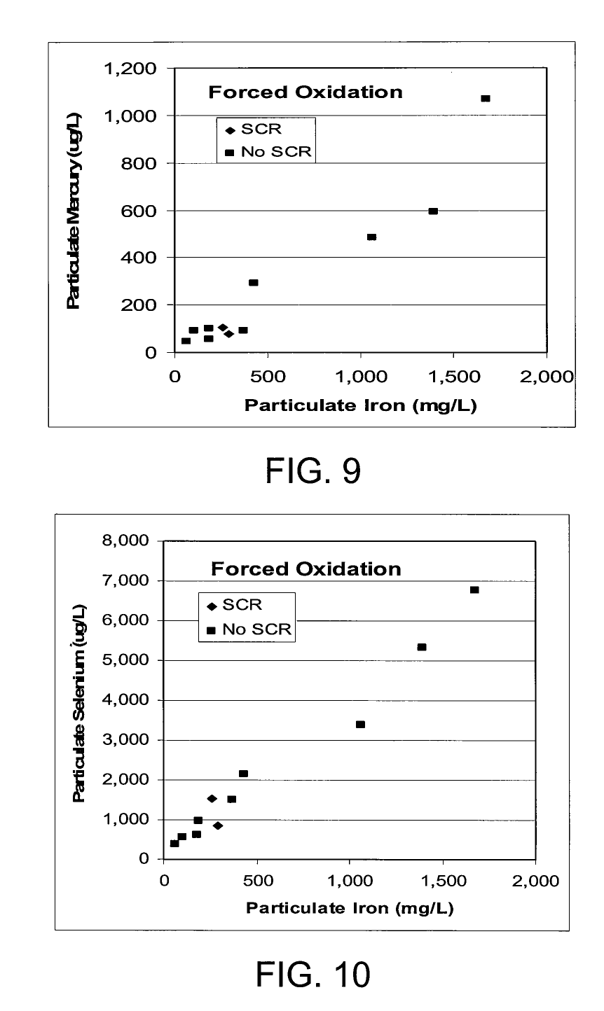

The effectiveness of iron addition for precipitating mercury, selenium and other metals is supported by data relating particulate iron to particulate metals in slurries for power plant using FGD systems. FIG. 9 shows a graph of particulate iron and mercury concentrations in various FGD system slurries. The data plotted in this graph suggests a direct correlation between particulate iron and particulate mercury in the slurries obtained from various forced oxidation FGD systems. Further, typically only about 1 percent of mercury in these slurries was in the soluble form, which supports a position that mercury is either precipitated in conjunction with iron, or is re-emitted, with little remaining in solution.

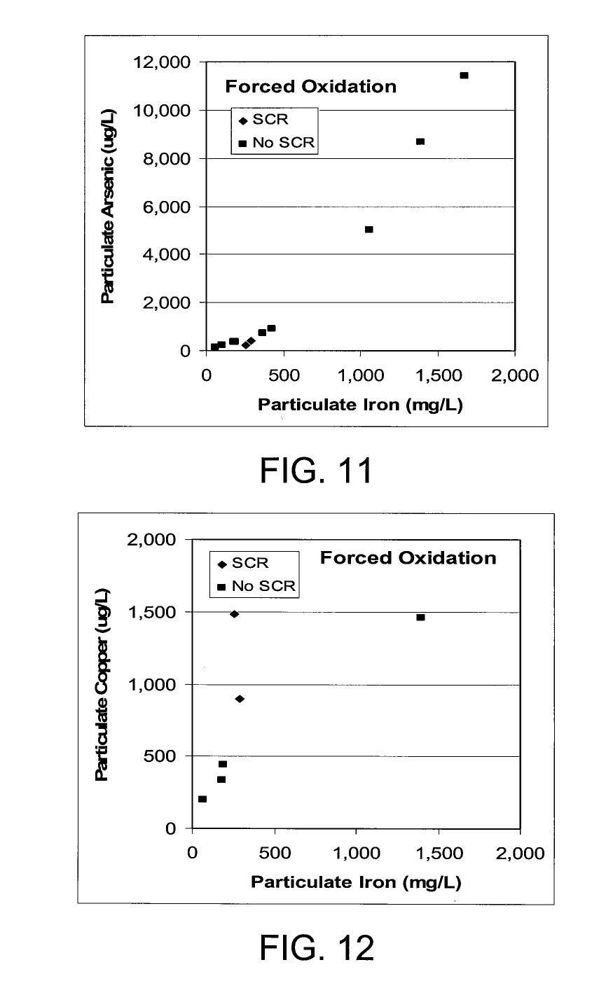

A similar correlation was found between particulate selenium and particulate iron, which is shown in FIG. 10. In contrast with mercury, there was significant soluble selenium present in the FGD slurries in the form of selenate. It appears that selenite is controlled and associated with particulate iron, and that selenate is soluble. Hence, iron appears to precipitate selenite, and selenite in excess of the amount precipitated by the available iron is converted to the soluble selenate form. Accordingly, adding iron to a FGD system may limit the formation of selenate in FGD systems by reducing the amount of selenite available for conversion to selenate. Similar correlations to the ones for mercury and selenium were observed for particulate arsenic with respect to particulate iron (FIG. 11), and for particulate copper with respect to particulate iron (FIG. 12).

All directional references (e.g., upper, lower, upward, downward, left, right, leftward, rightward, top, bottom, above, below, inner, outer, vertical, horizontal, clockwise, and counterclockwise) are only used for identification purposes to aid the reader's understanding of the examples of the invention, and do not create limitations, particularly as to the position, orientation, or use of the invention unless specifically set forth in the claims. Joinder references (e.g., attached, coupled, connected, joined, and the like) are to be construed broadly and may include intermediate members between a connection of elements and relative movement between elements. As such, joinder references do not necessarily infer that two elements are directly connected and/or in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

In methodologies directly or indirectly set forth herein, various steps and operations are described in one possible order of operation, but those skilled in the art will recognize that steps and operations may be rearranged, replaced, or eliminated or have other steps inserted without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

1. A method for treating flue gas, comprising:
adding iron to a slurry at a ratio of between approximately 20-to-1 and 5000-to-1 by weight of iron to a weight of a metal to be removed from a flue gas; and
contacting the slurry containing the added iron with the flue gas in a flue gas desulfurization system.

2. The method of claim 1, wherein the metal comprises mercury, and the ratio is between approximately 100-to-1 and 5000-to-1.

3. The method of claim 1, wherein the metal comprises selenium, and the ratio is between approximately 20-to-1 and 1000-to-1.

4. The method of claim 1, wherein the metal comprises a heavy metal.

5. The method of claim 4, wherein the heavy metal comprises at least one of the following: cadmium, arsenic, lead, and nickel.

6. (canceled)

7. The method of claim 1, wherein the iron comprises at least one of ferrous iron, ferric iron, and elemental iron.

8. The method of claim 1, further comprising grinding the iron into a powder.

9. The method of claim 1, further comprising adding the iron to the slurry prior to delivering the slurry to a sprayer operatively associated with a sorption spray tower.

10. The method of claim 1, further comprising adding the iron to the slurry in an oxidation reactor.

11. The method of claim 1, further comprising adding the iron to the slurry prior to delivering the slurry to an oxidation reactor.

12. The method of claim 1, wherein at least a portion of the slurry comprises a re-circulating slurry.

13. The method of claim 1, wherein the slurry comprises a limestone slurry.
